(19) United States
(12) Patent Application Publication
(10) Pub. No.: US 2016/0297222 A1
(43) Pub. Date: Oct. 13, 2016

(54) METHOD FOR PRINTING ON GLASS

(71) Applicant: CORNING INCORPORATED, Corning, NY (US)

(72) Inventors: Eric Lewis Allington, Campbell, NY (US); Matthew Lee Black, Naples, NY (US); Steven Edward DeMartino, Painted Post, NY (US); Matthew Wade Fenton, Elmira, NY (US); Jody Paul Markley, Watkins Glen, NY (US)

(21) Appl. No.: 15/038,591

(22) PCT Filed: Nov. 6, 2014
(86) PCT No.: PCT/US2014/064256

§ 371 Date: May 23, 2016

Related U.S. Application Data
(60) Provisional application No. 61/908,303, filed on Nov. 25, 2013.

(51) Int. Cl. B41M 5/00; C03C 17/42

(52) U.S. Cl. CPC B41M 5/0047; C03C 17/42; B41M 5/007; C03C 2217/70

(57) ABSTRACT

A method for printing ink on a substrate comprising the steps of coating a glass substrate with an adhesion promoter, depositing a first layer of ink on the coated substrate, depositing a second layer of ink over the first layer of ink, and depositing a powder coating onto the second layer of ink. The substrate can be a glass substrate, and the adhesion promoter can include a silane material or powder coating on the substrate.

This application claims the benefit of priority to U.S. Provisional Application No. 61/908303 filed on Nov. 25, 2013, the content of which is incorporated herein by reference in its entirety.

### BACKGROUND

The use of ink jet printing processes in the manufacture of multicolor images is known in the art. In conventional processes, ink droplets can be emitted from a nozzle and deposited on substrates to form an image. To obtain quality images, rapid absorption of the ink into the substrate is required, but at the same time the ink colorant must be retained at or near the surface of the substrate with lateral ink migration limited to the resolution of the printer.

Conventional ink jet printing processes, inks and substrates are capable of producing high quality four color images on paper substrates in sizes ranging from office copy up to sizes useful for posters, displays and billboards. However, application of ink jet printing has been limited largely to typical office uses such as copy and the like where environmental and abrasion damage to the finished ink image is unlikely to occur. When used as posters, displays, billboards and when used with glass substrates, water sensitive ink jet images and underlying substrates must be protected from rain, sunlight, and other environmental contaminants and should likewise be protected from abrasion and graffiti to provide adequate useful life to the image displayed. Thus, there continues to be an industry need for a process to provide protected, distortion-free, full-color ink jet images for use on large format posters, billboards, planar surfaces, architectural surfaces, appliances, non-planar surfaces, and the like.

### SUMMARY

Some embodiments of the present disclosure include a method for printing ink on a glass substrate. The method includes coating a glass substrate with a silane material, depositing a first layer of ink on the coated glass substrate, depositing a second layer of ink over the first layer of ink, and depositing a powder coating onto the second layer of ink.

Other embodiments include a method for printing ink on a glass substrate having the steps of depositing a first powder coating on a glass substrate, depositing a first layer of ink on the coated glass substrate, depositing a second layer of ink over the first layer of ink, and depositing a second powder coating onto the second layer of ink.

Additional embodiments include a method for printing ink on a substrate comprising the steps of coating a glass substrate with an adhesion promoter, depositing a first layer of ink on the coated substrate, depositing a second layer of ink over the first layer of ink, and depositing a powder coating onto the second layer of ink.

Additional features and advantages of the claimed subject matter will be set forth in the detailed description which follows, and in part will be readily apparent to those skilled in the art from that description or recognized by practicing the claimed subject matter as described herein, including the detailed description which follows, the claims, as well as the appended drawings.

It is to be understood that both the foregoing general description and the following detailed description present embodiments of the present disclosure, and are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles and operations of the claimed subject matter.

### BRIEF DESCRIPTION OF THE DRAWINGS

For the purposes of illustration, there are non-limiting forms shown in the drawings, it being understood, however, that the embodiments disclosed and discussed herein are not limited to the precise arrangements and instrumentalities shown.

FIG. 1 is a diagram of an exemplary procedure for one embodiment of the present disclosure.

FIG. 2 is a diagram of an exemplary procedure for another embodiment of the present disclosure.

FIG. 3 is a diagram of an exemplary procedure for a further embodiment of the present disclosure.

### DETAILED DESCRIPTION

Ink jet technology is not conventionally employed for production of printing techniques on glass substrates due to low adhesion characteristics on these substrates. Pretreatment of glass substrates has been employed in the industry; however, such methods have heretofore been unsuccessful in achieving high-quality prints. For example, pretreatment sprays such as, but not limited to, silane or other primers, have been utilized by the industry to increase the adhesion characteristics of ink to glass substrates to the level of other printing technologies (e.g., screen printing, pad printing) but this alone does not provide high quality adhesion characteristics.

Some embodiments of the present disclosure, however, can utilize conventional silane, or other, pretreatment methods and can incorporate a powder coating protective layer to encapsulate the decorative ink jet layer. This can therefore protect the printed substrate from the environment or other external events (e.g., scratching, etc.). In additional embodiments, the powder coating layer can be used as a color backer to broaden the ink jet color gamut (i.e., powder coating comes in a metallic silver, ink jet does not).

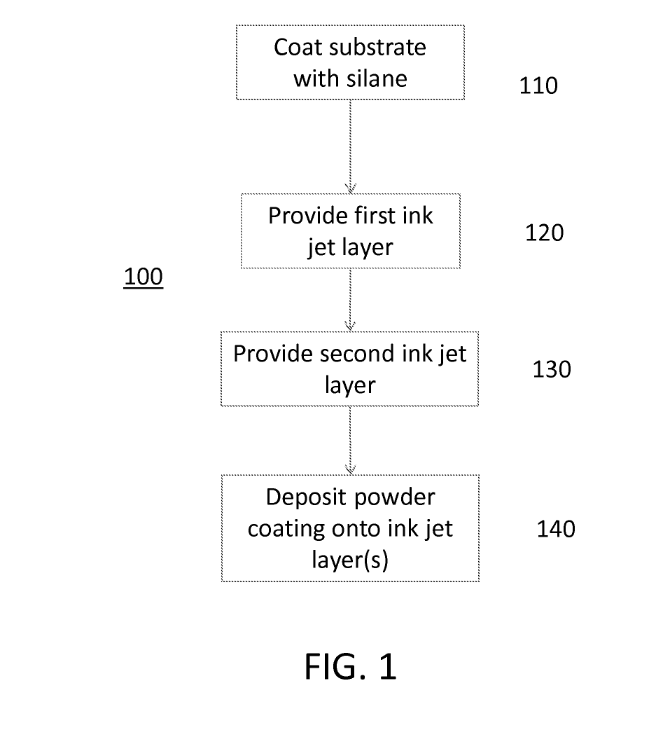

FIG. 1 is a diagram of an exemplary procedure for one embodiment of the present disclosure. With reference to FIG. 1, a procedure 100 is illustrated for providing a high quality printed image on a glass substrate. In step 110, an exemplary substrate such as, but not limited to, a glass substrate can be pre-treated with an adhesion promoter. An exemplary adhesion promoter utilized by some embodiments can be silane to increase ink adhesion to the substrate. In some embodiments, step 110 can include cleaning the substrate, pyrolysis of the substrate and then spraying of a silane treatment on the substrate. Exemplary silanes can include silanes having no functional groups or one or more functional groups. Some functional silanes or silanols can be utilized to assist in the adhesion of inks to the underlying substrate. Non-limiting compounds can include those having 2 reactive silyl groups such as, but not limited to, hydroxy terminated polydimethylsiloxanes and polydiethylsiloxanes (i.e., having Si—OH terminal groups). Other compounds can include three or more reactive silyl groups per molecule, e.g., alkoxy silyl or acyloxy silyl groups, 1,3-dimethyltetramethoxydisiloxane, methacryloxypropyltrimethoxysilane, tetraethoxy-silane, 1,3-dioctyltetramethoxy-disiloxane, glycidoxypropyltrimethoxysilane, 3-bromopropyltrimethoxysilane, and dioctyltetraethoxydisiloxane, to name a few. In step 120, a first ink layer can be deposited or provided over the coated substrate. This first ink layer can be deposited using conventional ink jet technology and can include any various artwork, customized or otherwise. Thus, step 120 can include depositing one or more ink images on the substrate. For example, an ink jet device can traverse over the substrate and deposit ink droplets on the coated substrate to form an imaged layer. An exemplary ink jet device can be any conventional ink jet printer used to print a single color or a full color image. Conventional ink jet printing methods and devices are disclosed by Werner E. Haas in “Imaging Processes and Materials,” Ed. by Sturge, Walworth & Shepp, which is incorporated herein in its entirety by reference thereto. Additional ink jet devices include, but are not limited to, Hewlett Packard Desk Jet 500 and 500C printers, IBM Lexmark® ink jet printers, Cannon Bubblejet® printers, NCAD Computer Corporation Novajet® printers, and the like. In this step, a single color ink image, e.g., black, green, etc., can be deposited or several colors can be deposited either in sequence or simultaneously, to form an ink imaged layer, e.g., a four color subtractive color image including yellow, magenta, cyan and black images in register. Unless the printed ink layer is to be used in the manufacture of a transparency, the ink image can be printed on the substrate as a reverse or mirror image so that the completed protected ink image will possess correct orientation when applied to an opaque substrate. Exemplary inks used in embodiments include ink compositions such as, but not limited to, liquid compositions comprising a solvent or carrier liquid, dyes or pigments, humectant, organic solvents, detergents, thickeners, preservatives, and the like. The solvent or carrier liquid can be water, although ink in which organic materials such as polyhydric alcohols as the predominant solvent or carrier can also be used. The dyes used in such compositions can be water-soluble direct or acid type dyes.

In step 130, a second ink layer can be deposited onto the first ink layer also using ink jet technology described above. Of course, this second ink layer can utilize the same or different technology than what was used to deposit the first layer. In some embodiments, the second ink layer can be solid white (or another suitable color(s)) to reduce or eliminate the transparency of the underlying glass substrate and provide a clearer picture of the image deposited in the first layer to an observer. In step 140, a powder coating can be deposited onto the second ink layer to provide a scratch- and environmentally-resistant coating for the ink layers. Exemplary powder material can include inorganic particles such as silicas, chalk, calcium carbonate, magnesium carbonate, kaolin, calcined clay, pyrophylite, bentonite, zeolite, talc, synthetic aluminum and calcium silicates, diatomatious earth, anhydrous silicic acid powder, aluminum hydroxide, barite, barium sulfate, gypsum, calcium sulfate, and the like. Suitable powder material can also include organic particles such as polymeric beads including beads of polymethylmethacrylate, copoly(methylmethacrylate/divinylbenzene), polystyrene, copoly(vinyltoluene/t-butylstyrene/methacrylic acid), polyethylene, and the like. The composition and particle size of the particles can be selected so as not to impair the transparent nature of the deposited ink. The powder material can be substantially transparent or can include a colorant. In some embodiments, the powder material can include components which strongly absorb ultraviolet radiation thereby reducing damage to underlying images by ambient ultraviolet light, e.g., such as 2-hydroxybenzophenones; oxalanilides, aryl esters and the like, hindered amine light stabilizers, bis(2,2,6,6-tetramethyl-4-piperidinyl) sebacate and the like, and combinations thereof. Other suitable powder coatings can include thermally activated, hydrophilic, adhesive material comprised of thermoplastic polyurethanes, polycaprolactone, acrylic copolymers, and combinations thereof. In some embodiments, the coated substrate can then be heat-treated or cured.

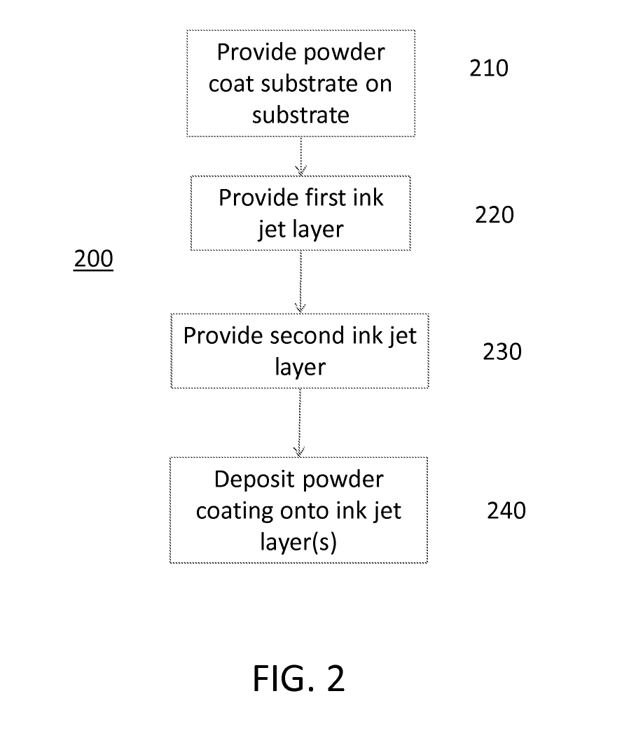

FIG. 2 is a diagram of an exemplary procedure for another embodiment of the present disclosure. With reference to FIG. 2, a procedure 200 is illustrated for providing a high quality printed image on a glass substrate. In step 210, an exemplary substrate such as, but not limited to, a glass substrate can be pre-treated with an adhesion promoter. An exemplary adhesion promoter utilized by some embodiments can be a powder coating which is sprayed directly on the glass to increase ink adhesion to the substrate. In some embodiments, step 210 can also include curing or heating of the powder coating on the substrate. Exemplary powder material can include inorganic particles such as silicas, chalk, calcium carbonate, magnesium carbonate, kaolin, calcined clay, pyrophylite, bentonite, zeolite, talc, synthetic aluminum and calcium silicates, diatomatious earth, anhydrous silicic acid powder, aluminum hydroxide, barite, barium sulfate, gypsum, calcium sulfate, and the like. Suitable powder material can also include organic particles such as polymeric beads including beads of polymethylmethacrylate, copoly(methylmethacrylate/divinylbenzene), polystyrene, copoly(vinyltoluene/t-butylstyrene/methacrylic acid), polyethylene, and the like. The composition and particle size of the particles can be selected so as not to impair the transparent nature of the ink to be deposited. The powder material can be substantially transparent or can include a colorant. In some embodiments, the powder material can include components which strongly absorb ultraviolet radiation thereby reducing damage to underlying images by ambient ultraviolet light, e.g., 2-hydroxybenzophenones; oxalanilides, aryl esters and the like, hindered amine light stabilizers, such as bis(2,2,6,6-tetramethyl-4-piperidinyl) sebacate and the like, and combinations thereof. This first powder coating can be utilized to permanently adhere printed ink to the underlying substrate. Other suitable powder coatings can include thermally activated, hydrophilic, adhesive material comprised of thermoplastic polyurethanes, polycaprolactone, acrylic copolymers, and combinations thereof.

In step 220, a first ink layer can be deposited or provided over the coated substrate. This first ink layer can be deposited using conventional ink jet technology and can include any various artwork, customized or otherwise. Step 220 can include depositing one or more ink images on the substrate. For example, an ink jet device can traverse over the substrate and deposit ink droplets on the coated substrate to form an imaged layer. An exemplary ink jet device can be any conventional ink jet printer used to print a single color or a full color image. Conventional ink jet printing methods and devices are disclosed by Werner E. Haas in “Imaging Processes and Materials,” Ed. by Sturge, Walworth & Shepp, which is incorporated herein in its entirety by reference thereto. Additional ink jet devices include, but are not limited to, Hewlett Packard Desk Jet 500 and 500C printers, IBM Lexmark® ink jet printers, Cannon Bubblejet® printers, NCAD Computer Corporation Novajet® printers, and the like. In this step, a single color ink image, e.g., black, green, etc., can be deposited or several colors can be deposited either in sequence or simultaneously, to form an ink imaged layer, e.g., a four color subtractive color image including yellow, magenta, cyan and black images in register. Unless the printed ink layer is to be used in the manufacture of a transparency, the ink image can be printed on the substrate as a reverse or mirror image so that the completed protected ink image will possess correct orientation when applied to an opaque substrate. Exemplary inks used in embodiments include ink compositions such as, but not limited to, liquid compositions comprising a solvent or carrier liquid, dyes or pigments, humectant, organic solvents, detergents, thickeners, preservatives, and the like. The solvent or carrier liquid can be water, although ink in which organic materials such as polyhydric alcohols as the predominant solvent or carrier can also be used. The dyes used in such compositions can be water-soluble direct or acid type dyes. In step 230, a second ink layer can be deposited onto the first ink layer also using ink jet technology described above. Of course, this second ink layer can utilize the same or different technology than what was used to deposit the first layer. In some embodiments, the second ink layer can be solid white (or another suitable color(s)) to reduce or eliminate the transparency of the underlying glass substrate and provide a clearer picture of the image, deposited in the first layer, to an observer. In step 240, a second powder coating can be deposited onto the second ink layer to provide a scratch- and environmentally-resistant coating for the ink layers. The material utilized in the second powder coating can be the same or different than the first powder coating as described above. The second powder coating can be substantially transparent or can include a colorant. In some embodiments, the coated substrate can then be heat-treated or cured.

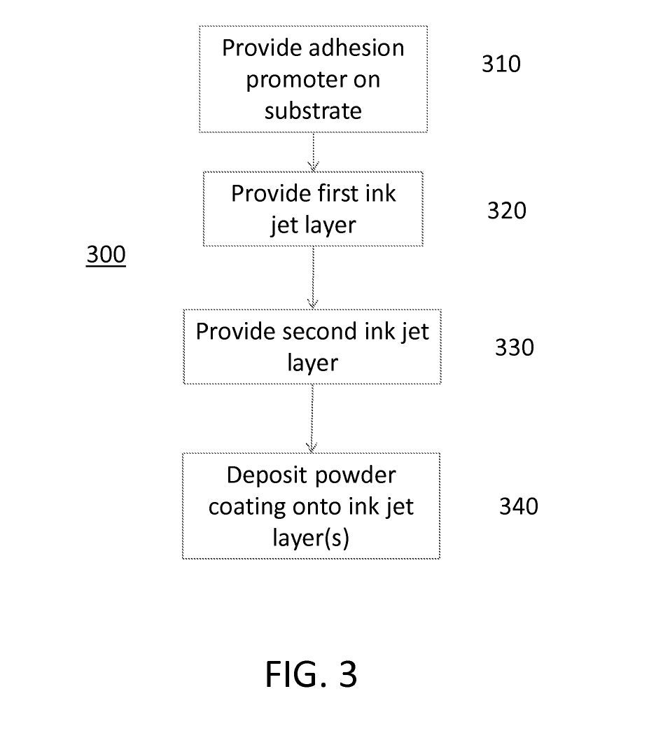

FIG. 3 is a diagram of an exemplary procedure for a further embodiment of the present disclosure. With reference to FIG. 3, a procedure 300 is illustrated for providing a high quality printed image on a glass substrate. In step 310, an exemplary substrate such as, but not limited to, a glass substrate can be pre-treated with an adhesion promoter. Exemplary adhesion promoters include, but are not limited to, silanes and powder coatings, each of which are described above with reference to FIGS. 1 and 2, respectively. In step 320, a first ink layer can be deposited or provided over the coated substrate. This first ink layer can be deposited using conventional ink jet technology and can include any various artwork, customized or otherwise. In step 330, a second ink layer can be deposited onto the first ink layer also using ink jet technology. This second ink layer can utilize the same or different technology than what was used to deposit the first layer. In some embodiments, the second ink layer can be solid white (or another suitable color(s)) to reduce or eliminate the transparency of the underlying glass substrate and provide a clearer picture of the image deposited in the first layer to an observer. In step 340, a powder coating can be deposited onto the second ink layer to provide a scratch- and environmentally-resistant coating for the ink layers. This powder coating can be substantially transparent or can include a colorant. In some embodiments, the coated substrate can then be heated or cured.

While substrates heretofore have been generically referred to as substrates or glass substrates, the claims appended herewith are applicable to any type of substrate, glass or otherwise (metal, transparent film, polymeric material, etc.). In some embodiments having a glass substrate, the glass can be chemically-strengthened or non-chemically-strengthened glass. For example, some embodiments can include chemically strengthened glass (e.g., Gorilla Glass) having a high compressive stress (CS) level, a relatively high depth of compressive layer (DOL), and/or moderate central tension (CT). The thicknesses of this glass can range from about 0.3 mm to about 2.1 mm (and all subranges therebetween) or greater. Other embodiments can include thinner chemically strengthened or non-chemically strengthened glass such as Willow Glass. Such thicknesses can be less than 0.5 mm to 0.1 mm or thinner.

Utilizing embodiments described herein, an exemplary powder coating can prevent damage to the ink layer and therefore create an industry accepted ink jet on glass product. By printing on the backside of the glass and encapsulating the ink jet layer with a hardened powder coating layer, the problem of durability can be solved. Further, in some embodiments, by spraying a layer of powder coating directly on the glass, printing on the powder coating, and then encapsulating with another layer of powder coating the adhesion problem can be solved.

Exemplary embodiments can thus provide cost effective powder coatings that are recyclable and emit zero or near zero volatile organic compounds. Embodiments can also provide high temperature resistance, high fracture toughness, cracking resistance, and protection of underlying ink jet layers. Exemplary embodiments can also utilize a transparent powder coating layer or a color powder coating layer to encapsulate an image and also to broaden the ink jet color gamut. Through such processes, exemplary embodiments can utilize antimicrobial additives to one or more surfaces of the glass substrate and can provide color stability and hermetic sealing of images not provided by conventional processes. Exemplary processes described above can meet chemical testing and hardness and scratch testing after water bath, cyclic moisture, dry heat, NaOH, H₂SO₄, and mineral oil exposures. Further, exemplary processes described above can meet mechanical testing such as a 5b rating on cross-hatch adhesion tests and above a 3H rating on pencil hardness tests. Embodiments herein also provide a broader range of thermal stability, the ability for use of ink jetted glass substrates in external environments, use of ink jetted glass substrates in lighting and informational applications. Due to the various uses of chemically strengthened glass as a glass substrate, additional applications include anti-counterfeiting codes, anti-graffiti applications, printing of unique codes on curved glass, customized artwork on curved substrates (e.g., appliances) and customized decorated glass for automotive applications.

In some embodiments, a method for printing ink on a glass substrate is provided. The method includes coating a glass substrate with a silane material, depositing a first layer of ink on the coated glass substrate, depositing a second layer of ink over the first layer of ink, and depositing a powder coating onto the second layer of ink. In another embodiment, the method includes curing the glass substrate having a deposited powder coating thereon. An exemplary silane material can be, but is not limited to, silanes having no functional groups, silanes having one or more functional groups, and combinations thereof. An exemplary powder coating includes material having inorganic particles, organic particles, thermally activated materials, components which absorb ultraviolet radiation, and combinations thereof. The first layer of ink can include a color image having a plurality of colors, and the second layer of ink can be solid white. In some embodiments, the glass substrate can have a thickness ranging from about 0.1 mm to about 2.2 mm. In other embodiments, the glass substrate can be chemically strengthened glass.

In other embodiments a method for printing ink on a glass substrate can include the steps of depositing a first powder coating on a glass substrate, depositing a first layer of ink on the coated glass substrate, depositing a second layer of ink over the first layer of ink, and depositing a second powder coating onto the second layer of ink. In another embodiment, the method includes curing the glass substrate having a deposited second powder coating thereon. The first and second powder coatings can include material such as, but not limited to, inorganic particles, organic particles, thermally activated materials, components which absorb ultraviolet radiation, and combinations thereof. Of course, the first and second powder coatings can be different. The first layer of ink can include a color image having a plurality of colors, and the second layer of ink can be solid white. In some embodiments, the glass substrate can have a thickness ranging from about 0.1 mm to about 2.2 mm. In other embodiments, the glass substrate can be chemically strengthened glass.

In further embodiments, a method for printing ink on a substrate can include the steps of coating a glass substrate with an adhesion promoter, depositing a first layer of ink on the coated substrate, depositing a second layer of ink over the first layer of ink, and depositing a powder coating onto the second layer of ink. In another embodiment, the method includes curing the glass substrate having a deposited powder coating thereon. Exemplary adhesion promoters can include a silane material or a powder coating. An exemplary powder coating material can include, but is not limited to, inorganic particles, organic particles, thermally activated materials, components which absorb ultraviolet radiation, and combinations thereof. The first layer of ink can include a color image having a plurality of colors, and the second layer of ink can be solid white. In some embodiments, the substrate can be a glass substrate and can have a thickness ranging from about 0.1 mm to about 2.2 mm. This glass substrate can be, in some embodiments, chemically strengthened glass.

While this description may include many specifics, these should not be construed as limitations on the scope thereof, but rather as descriptions of features that may be specific to particular embodiments. Certain features that have been heretofore described in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and may even be initially claimed as such, one or more features from a claimed combination may in some cases be excised from the combination, and the claimed combination may be directed to a subcombination or variation of a subcombination.

It is also to be understood that, as used herein the terms “the,” “a,” or “an,” mean “at least one,” and should not be limited to “only one” unless explicitly indicated to the contrary. Thus, for example, reference to “a transducer” includes examples having two or more such transducers unless the context clearly indicates otherwise. Likewise, a “plurality” or an “array” is intended to denote “more than one.” As such, an “array of excitation locations” or a “plurality of excitation locations” includes two or more such excitation locations, such as three or more such excitation locations, etc.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, “substantially equal” is intended to denote that two values are equal or approximately equal, and “substantially similar” is intended to denote, e.g., that one element is approximately the same shape as another element.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an assembly that comprises A+B+C include embodiments where an assembly consists of A+B+C and embodiments where an assembly consists essentially of A+B+C.

It is also noted that recitations herein refer to a component of the present disclosure being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

As shown by the various configurations and embodiments illustrated in the figures, various methods for ink jet printing on glass substrates have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof

1.-27. (canceled)

28. A method for printing ink on a glass substrate comprising the steps of:
coating a glass substrate with a silane material;
depositing a first layer of ink on the coated glass substrate;
depositing a second layer of ink over the first layer of ink; and
depositing a powder coating onto the second layer of ink.

29. The method of claim 28, further comprising the step of curing the glass substrate having a deposited powder coating thereon.

30. The method of claim 28, wherein the silane material is selected from the group consisting of silanes having no functional groups, silanes having one or more functional groups, and combinations thereof.

31. The method of claim 28, wherein the powder coating includes material selected from the group consisting of inorganic particles, organic particles, thermally activated materials, components which absorb ultraviolet radiation, and combinations thereof.

32. The method of claim 28, wherein the first layer of ink includes a color image having a plurality of colors.

33. The method of claim 28 wherein the second layer of ink is solid white.

34. The method of claim 28 wherein the glass substrate has a thickness ranging from about 0.1 mm to about 2.2 mm.

35. The method of claim 28 wherein the glass substrate is chemically strengthened glass.

36. A product made from the process of claim 28.

37. A method for printing ink on a glass substrate comprising the steps of:
depositing a first powder coating on a glass substrate;
depositing a first layer of ink on the coated glass substrate;
depositing a second layer of ink over the first layer of ink; and
depositing a second powder coating onto the second layer of ink.

38. The method of claim 37 further comprising the step of curing the glass substrate having a deposited second powder coating thereon.

39. The method of claim 37 wherein the first and second powder coatings include material selected from the group consisting of inorganic particles, organic particles, thermally activated materials, components which absorb ultraviolet radiation, and combinations thereof.

40. The method of claim 37 wherein the first and second powder coatings are different.

41. The method of claim 37 wherein the first layer of ink includes a color image having a plurality of colors.

42. The method of claim 37 wherein the second layer of ink is solid white.

43. A product made from the process of claim 37.

44. A method for printing ink on a substrate comprising the steps of:
coating a glass substrate with an adhesion promoter;
depositing a first layer of ink on the coated substrate;
depositing a second layer of ink over the first layer of ink; and
depositing a powder coating onto the second layer of ink.

45. The method of claim 44 further comprising the step of curing the glass substrate having a deposited powder coating thereon.

46. The method of claim 44 wherein the adhesion promoter is a silane material or a powder coating.

47. The method of claim 46 wherein the powder coating includes material selected from the group consisting of inorganic particles, organic particles, thermally activated materials, components which absorb ultraviolet radiation, and combinations thereof.
